(19) United States
(12) Patent Application Publication
(10) Pub. No.: US 2019/0170595 A1
(43) Pub. Date: Jun. 6, 2019

(54) PRESSURE DIFFERENCE SENSOR FOR DETERMINING A PRESSURE MEASUREMENT SIGNAL

(71) Applicant: Endress+Hauser SE+Co. KG, Maulburg (DE)

(72) Inventors: Timo Kober, Potsdam (DE); Benjamin Lemke, Berlin (DE)

(21) Appl. No.: 16/315,233

(22) PCT Filed: Jun. 26, 2017
(86) PCT No.: PCT/EP2017/065634

§ 371 Date: Jan. 4, 2019

(30) Foreign Application Priority Data
Jul. 6, 2016 (DE) 10 2016 112 352.8

(51) Int. Cl. G01L 13/02; G01L 19/00; G01L 19/06

(52) U.S. Cl. CPC G01L 13/025; G01L 19/069; G01L 19/0084

(57) ABSTRACT

A pressure difference sensor for determining a pressure measurement signal includes a measuring cell made from a semiconductor material. The measuring cell is suppliable with first and second pressures and, using an electrical transducer element, outputs the pressure measurement signal as a function of a difference between the first and second pressures. First and second stiffening elements of a ceramic or semiconductor material are each joined with the pressure difference measuring cell by a respective first or second joining layer and have a respective first or second duct, via which the respective first or second pressure is suppliable to the pressure difference measuring cell. The first and/or the second joining layer comprise(s) an electrically conductive material and serve(s) for the mechanical connecting of the pressure difference measuring cell with the first and second stiffening elements and for implementing an electrical functionality.

The invention relates to a pressure difference sensor for determining a pressure measurement signal.

Pressure difference sensors are applied in industrial measurements technology for measuring pressures. They comprise pressure difference measuring cells (frequently also referred to as semiconductor sensors or sensor chips), which can be produced by to applying processes known from semiconductor technology on an undivided wafer.

Such pressure difference measuring cells comprise regularly two platforms, between which a measuring membrane is arranged. In such case, there is provided in each of the two platforms, in each case, a pressure chamber enclosed beneath the measuring membrane. In measurement operation, one side of the measuring membrane is supplied via a passageway in one of the two platforms with a first pressure and the other side of the measuring membrane via a passageway in the second platform with a second pressure.

By supplying with the first and second pressures, the measuring membrane experiences a pressure difference dependent deflection, which can be ascertained using various measuring systems, in order to derive a pressure measurement signal. In principle, resistive, inductive and capacitive methods are available for sensing the deflection. In the case of capacitive pressure difference measuring cells, these regularly have a conductive measuring membrane, which together with an electrode integrated in one of the platforms form a capacitor with a capacitance dependent on the pressure acting on the measuring membrane, which capacitance can be determined by means of a measuring system connected to the capacitor.

In order to increase the bursting strength of such pressure difference measuring cells, they are, as a rule, arranged between two mechanically stable supports, or stiffening bodies, each of which is equipped with a pressure transfer line, whose one end is connected via the passageway in the platform adjoining the support body with the pressure chamber enclosed in the platform and whose other end is supplied via a pressure supply connected thereto with one of the two pressures.

In order to achieve an as stable as possible mechanical connection between the pressure difference measuring cell and the stiffening bodies, the stiffening bodies are connected with the pressure measuring cell via a metal joining method. Used as metal joining method can be, for example, a method known from the state of the art. Disadvantageous in the case of these joining methods is that an electrically conductive joining layer is required, which, in turn, leads to disadvantageous electrical effects in the case of the evaluation of the pressure measurement signal of the pressure difference measuring cell.

An object of the invention is to provide a pressure difference measuring cell, wherein the disadvantages arising because of the electrically conductive joining layers are minimized, or reduced.

The object of the invention is achieved by a pressure difference sensor for determining a pressure measurement signal, comprising:

a pressure difference measuring cell essentially of a semiconductor material, preferably silicon, wherein the pressure difference measuring cell is suppliable with first and second pressures and, with the assistance of an electrical transducer element, outputs the pressure measurement signal as a function of a difference between the first and second pressures;

a first stiffening element preferably of a ceramic or semiconductor material, wherein the first stiffening element is joined with the pressure difference measuring cell by means of a first joining layer and has a first duct, via which the first pressure is suppliable to the pressure difference measuring cell;

a second stiffening element preferably of a ceramic or semiconductor material, wherein the second stiffening element is joined with the pressure difference measuring cell by means of a second joining layer and has a second duct, via which the second pressure is suppliable to the pressure difference measuring cell;

wherein the first and/or the second joining layer comprise(s) an electrically conductive, preferably metal, material and the first and/or second joining layer serve(s) besides for the mechanical connection of the pressure difference measuring cell with the first and second stiffening elements also for implementing an electrical functionality.

According to the invention, thus, the actually undesired, thus, disadvantageous, electrical property of the joining layer, or—layers is utilized to give the pressure difference sensor another electrical functionality. Among such electrical functionalities are especially desired functionalities, i.e. a functionality giving the pressure difference sensor an advantageous use. For example, such electrical functionalities can be the electrical connecting of two components of the pressure difference sensor. However, also use of the joining layers for electrical shielding of the pressure difference sensor is such a desired electrical functionality.

An advantageous, further development of the invention provides that for implementing the electrical functionality the first and/or the second joining layer are/is connected with at least one component of the electrical transducer element.

Especially, the further development provides that the pressure difference measuring cell has first and second platforms, each of which comprises a layer structure of at least a first electrically conductive layer as well as a first and a second insulation layer,

wherein each of the first and second platforms is connected via the first insulation layer pressure-tightly with a measuring membrane in a peripheral edge region,

wherein the first insulation layer is structured, in each case, in such a manner that, in each case, a pressure chamber is formed between the measuring membrane and the first electrically conductive layer,

wherein each of the first and second platforms is joined via the first and second joints, respectively, each of which is applied on a second insulation layer (108) of the first and second platforms, respectively, with the first and second stiffening elements, respectively,

wherein each of the first and second platforms has a passageway, so that the first and second pressures, respectively, are suppliable to their pressure chambers, in order to enable a pressure-dependent deflection of the measuring membrane,

wherein the pressure-dependent deflection of the measuring membrane is registered via at least one capacitance, which is formed between the measuring membrane as first electrode and at least one subregion of a first electrically conductive layer as second electrode,

wherein the second electrode as a component of the electrical transducer element is electrically contacted at least partially through the first, or second, joint with, in each case, an electrode terminal, so that the first or second joint serves at least partially as electrical conductor, or electrically conductive connection.

Additionally, the further development can provide that the electrode terminals are arranged on outer surfaces of the first and second platforms extending essentially perpendicularly to the measuring membrane and/or the electrode terminals are applied in the form of electrically conductive electrode terminal layers applied on the outer surfaces.

An alternative further development can provide that the electrode terminals are implemented by an outer surface of the first, or second, stiffening element extending essentially perpendicularly to the measuring membrane and/or the first, or second, stiffening element comprises a semiconductor material and the outer surface of the first, or second, stiffening element forms the electrode terminals.

An advantageous, further development can, in turn, provide that the layer structure has, furthermore, in each case, at least one further insulation layer, which is arranged preferably on the first electrically conductive layer, and a further electrically conductive layer, which is arranged preferably between the second insulation layer and the further insulation layer.

Another advantageous, further development can provide that the first electrically conductive layer is structured in such a manner that the second electrode is separated by a groove from an outer edge of the first electrical layer, so that the second electrode is electrically isolated from the outer edge.

Another advantageous, further development can, furthermore, provide that a guard-circuit is present for setting a potential and applying such at least to the further electrically conductive layer and/or the outer edge, wherein the guard-circuit is embodied such that it taps an electrode potential of the second electrode and the potential is set in such a manner that it essentially tracks the electrode potential. Especially, the further development provides that the first and second stiffening elements comprise a semiconductor material, and the guard-circuit is, furthermore, embodied to apply the potential to an electrically conductive subregion of the first and second stiffening elements.

In the case of an additional, advantageous, further development, it can be provided that the guard-circuit is, furthermore, embodied such that it applies no potential to the first and/or second joining layer(s).

An alternative further development provides that the at least one component is a guard-circuit for setting a shield potential and applying such at least to the first and/or second joining layer(s) and the guard-circuit is embodied such that it taps an electrode potential of the second electrode as a component of the electrical transducer element and the shield potential is set in such a manner that it essentially tracks the electrode potential, so that the first and/or second joining layer(s) serve(s) as an electrical shield layer for the pressure difference measuring cell.

The invention will now be explained in greater detail based on the appended drawing, the figures of which show as follows:

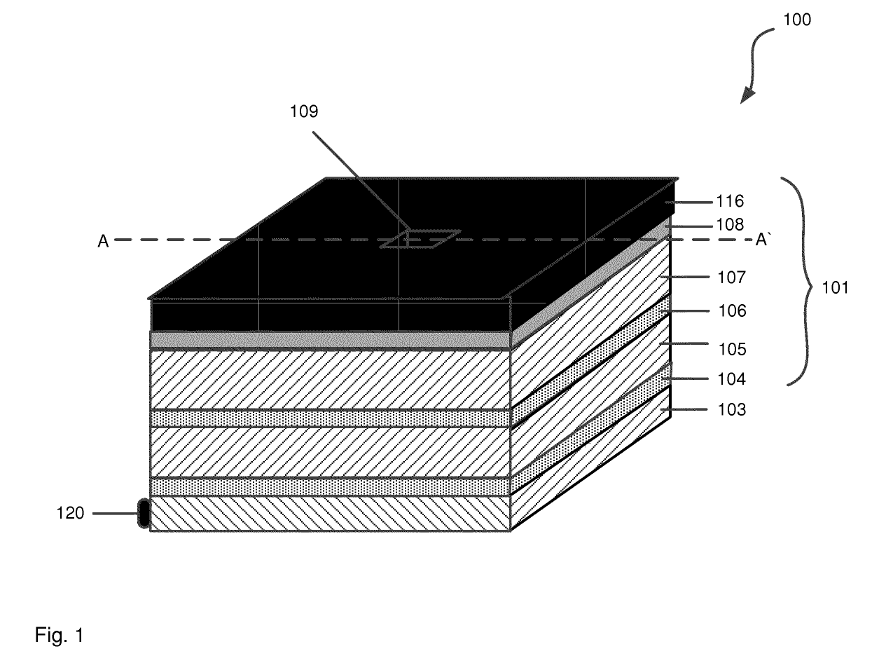

FIG. 1 a schematic view of a platform as part of a pressure difference sensor, in order to illustrate the position of a cutting plane A-A′,

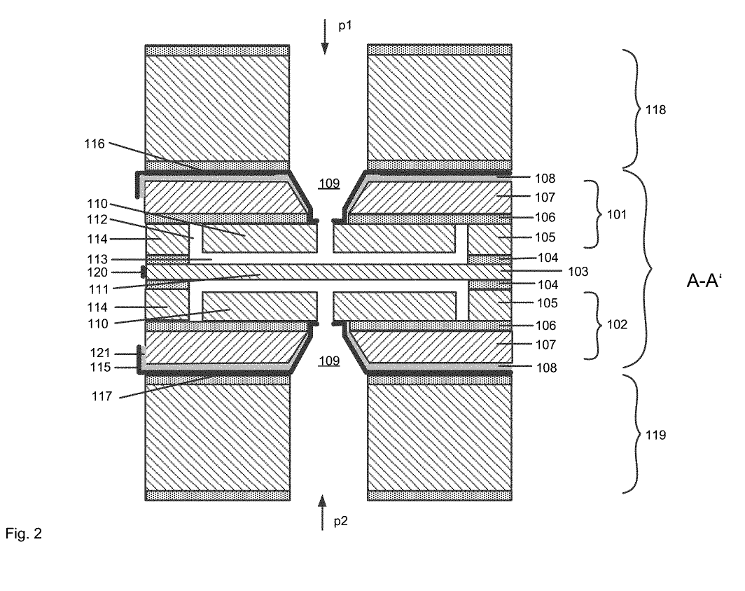

FIG. 2 a sectional view of a first example of an embodiment of a pressure difference sensor according to the cutting plane A-A′ of FIG. 1,

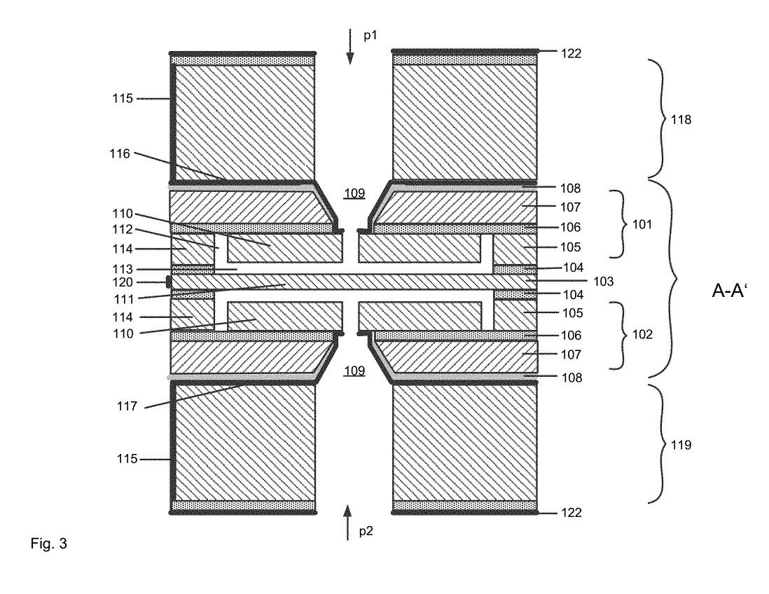

FIG. 3 a sectional view of a second example of an embodiment of a pressure difference sensor according to the cutting plane A-A′ of FIG. 1,

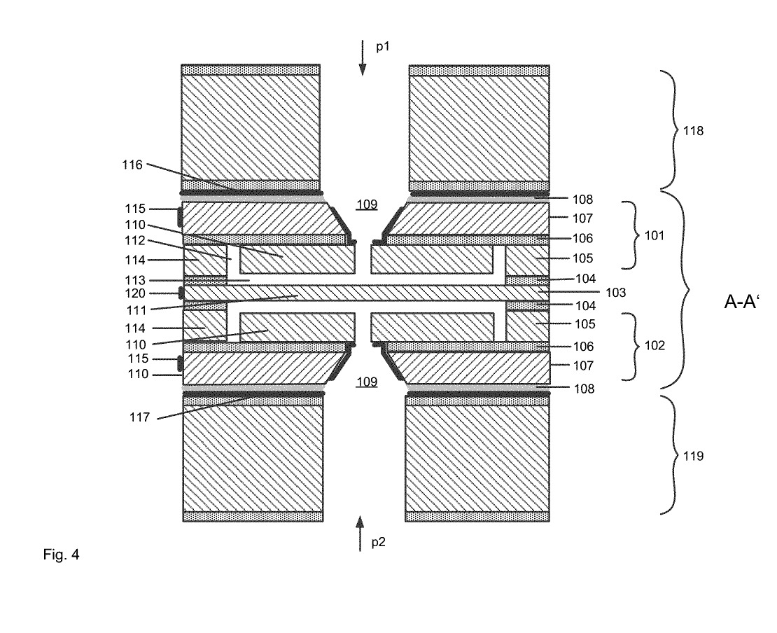

FIG. 4 a sectional view of a third example of an embodiment of a pressure difference sensor according to the cutting plane A-A′ of FIG. 1.

FIG. 1 shows a schematic view of a platform 101, which is part of a pressure difference sensor. FIG. 1 especially serves for indicating the orientation of the other figures of the drawing. The sectional views of FIGS. 2 to 4 show the layer structure of different forms of embodiment of a pressure difference sensor of the invention along the cutting plane A-A′ of FIG. 1. The cutting plane goes essentially centrally through the platform illustrated in FIG. 1.

In principle, a pressure difference sensor of the invention includes a pressure difference measuring cell 100, which is embodied essentially of a semiconductor material. Typically used as semiconductor material is silicon, which is appropriately structured, or processed, through standardized processes, which are known, for example, from the semiconductor industry. The pressure difference measuring cell 100 is joined with a first stiffening element 118 via, or by, a first joining layer 116, which is composed of a metal material, and with a second stiffening element 119 via, or by, a second joining layer 117, which likewise is composed of a metal material, in order to avoid bursting the pressure difference measuring cell 100 in the case of a pressure that is too large.

The first and second stiffening elements 118, 119 can, for example, be composed of a ceramic. Alternatively, the first and second stiffening elements 118, 119 can, however, also be made of a semiconductor material. For joining the first and second stiffening elements 118, 119 with the pressure difference measuring cell 100, all joining methods can be considered, which enable a semiconductor material, such as silicon, to be connected mechanically with a ceramic or, in given cases, also with another semiconductor material via a metal joint.

The pressure difference measuring cell 100 comprises an electrical, capacitive transducer element with a pressure sensitive, electrically conductive measuring membrane 103 arranged between first and second platforms 101, 102, wherein the measuring membrane 103 is connected by first insulation layers 104 with the first and second platforms 101, 102. In order to enable a pressure-dependent deflection of the measuring membrane 103, the first insulation layers 104 are structured in such a manner that pressure chambers 113 result between the measuring membrane 103 and first electrically conductive layers 105 of the first and second platforms 101, 102. In this way, a first side of the measuring membrane 103 can be supplied via a passageway 109 in the first platform 101 with a first pressure p1 and a second side of the measuring membrane 103 via a passageway 109 in the second platform 102 with a second pressure p2.

The two platforms 101, 102 comprise, furthermore, in each case, a layer structure of at least one electrically conductive layer 105, preferably a plurality of electrically conductive layers 105, 107 and at least two insulation layers 104, 106. The layer structure is preferably alternately embodied by the electrically conductive layers 105, 107 and the insulation layers 104, 106. Usually, a semiconductor material, such as, for example, silicon, serves as basic material for the platform 101, 102. Preferably, the platforms 101, 102 are produced in large quantity in a wafer composite, wherein for structuring and/or processing the wafer manufacturing processes known from the semiconductor technology are inserted. In this way, a silicon oxide layer can be manufactured, or prepared, from the basic material, for example, as insulation layer, or electrically insulating layer. Used as electrically conductive layers are usually layers essentially composed of a highly doped, semiconductor material.

In the example of an embodiment illustrated in FIG. 2, the layer structure of each platform 101, 102 includes a first outer insulation layer 104, a first electrically conductively layer 105, which is arranged on the first outer insulation layer 104, arranged on the first electrically conductive layer 105 a further, inner insulation layer 110, on which, in turn, a further, inner, electrically conductive layer 107 is arranged, and a second outer insulation layer 108, which is arranged on the additional inner, electrically conductive layer 107. In principle, the example of an embodiment is not dependent on the number of layers. Important only is that the first and second platforms 101, 102 have outer, first and second insulation layers 104, 108, which electrically insulate the layer externally. Regarding the layer structure illustrated in FIGS. 1 and 2, it is to be noted that this should only display the construction in principle and not to scale.

Additionally, the two platforms 101, 102 include, in each case, a second electrode 110 spaced from the measuring membrane 103, which together with the measuring membrane 103 as first electrode 111, in each case, forms a capacitor with a capacitance C1, or C2, as the case may be. The capacitances C1 and C2 change as a function of deflection of the measuring membrane 103 dependent on pressure acting on the measuring membrane 103. The second electrode 110 is formed at least by a subregion of the membrane-facing, first electrically conductive layer 105. For this, the first electrically conductive layer 105 is structured in such a manner that the second electrode 110 is separated by a groove 112 from an outer edge 114, so that the second electrode 110 is electrically isolated from the outer edge 114 of the first electrically conductive layer 105.

Additionally, the pressure difference sensor includes for each second electrode 110, in each case, an electrode terminal 115, which is connected, in each case, via an electrically conductive connection, or an electrical conductor, 116 with the second electrode 110. The electrically conductive connection 116 is preferably embodied of mutually interconnected subregions, or conductor subregions.

According to the invention, the electrode terminals 115 are electrically connected with the second electrode 110, in such case, via first, and second, metal joining layers 116, 117 as at least one subregion of the conductive connection. This means that the first and/or the second joining layer 116, 117 serve(s) not only for mechanical connection of the pressure difference measuring cell 100 with the first, and second, stiffening element 118, 119, respectively, but also fulfill(s) an electrical functionality in the form of an electrically conductive connection. Besides the first and/or second joining layers 116, 117, other electrically conductive subregions, which are embodied, for example, as coated metallizing, can as serve other parts of the electrically conductive connection.

Additionally, the pressure difference sensor 100 includes a membrane terminal 120. Since the measuring membrane 103 is accessible from all external sides of the sensor, this terminal can basically be implemented by the most varied of known methods of the state of the art. Preferably, the membrane terminal 120 is also arranged on an outer surface of the pressure difference sensor 100, especially that of the measuring membrane 103, extending perpendicularly to the measuring membrane 103.

Via the electrode terminals 115 and the membrane terminal 120, then the capacitance C1, and C2, of the two capacitors can be measured, in order to determine the pressure measurement signal, and then the pressure difference. Fundamentally, the pressure difference can be determined based on either of the two measured capacitances C1, C2. Preferably, the difference pressure determination occurs, however, not based on the individual measured capacitances, but, instead, based on a differential change f of the two capacitances C1, C2. The differential change f can be determined e.g. as a product of a constant k and a difference between the inverses of the capacitances C1, C2 according to: f=k(1/C1−1/C2), and has an approximately linear dependence on the pressure difference to be measured.

In the first example of an embodiment of the invention illustrated in FIG. 2, the electrode terminals 115 are arranged on an outer surface of the first and second platforms 101, 102 extending essentially perpendicularly to the measuring membrane 103. Provided for this on the outer surface of the first and second platforms 101, 102 are electrically conductive electrode terminals 115, which are produced, for example, in the form of a metallizing. Preferably, the electrode terminals 115 are embodied on the outer surface of the additional electrically conductive layer 107, wherein an electrode insulating layer 121, for example, a silicon oxide layer, is provided between the electrode terminals 115 and the additional electrically conductive layer 107.

The pressure difference sensor according to the first example of an embodiment of the invention includes, furthermore, a so-called guard-circuit for setting a potential and applying the potential to any electrically conductive layer. Such guard-circuits are known from the state of the art and are described, for example, in the international application with the international publication number WO 2016/066306 A1 (US2017315008), the content of which is incorporated here by reference. Especially, reference is made to the description for FIG. 5 of WO 2016/066306 A1.

In the first example of an embodiment, the guard-circuit taps an electrode potential of the second electrode, for example, via the corresponding electrode terminal 115, and controls a potential in such a manner that it essentially equals the electrode potential. The guard-circuit is embodied in such a manner that the potential is applied at least to the further electrically conductive layer 107. Preferably, the potential is applied to the outer edge 114 of the first electrical layer 105, which is electrically isolated from the second electrode 110, and/or to each additional electrically conductive layer except the second electrode 110. In this way, parasitic capacitive effects, which arise because there is, in each case, a capacitive coupling not only between the pressure-dependently deforming region of the measuring membrane 103 and the electrodes lying opposite thereto, but also between the electrodes and their environment and between the measuring membrane and its environment, can be minimized. Furthermore, in the case of the first example of an embodiment in FIG. 2, in the case, in which the first and/or second stiffening element comprises a semiconductor material, the potential is also applied to all electrically conductive regions of the first and/or second stiffening element 118, 119.

The second example of an embodiment in FIG. 3 differs from that illustrated in FIG. 2 in that the electrode terminals 115 are not on the outer surface of the first and second platforms 101, 102, but, instead, on an outer surface of the first and/or second stiffening element 118, 119. Furthermore, the stiffening elements 118, 119 are preferably of a semiconductor material, such as, for example, silicon and the electrode terminals 115 are the outer surfaces of the first, and second, stiffening elements 118, 119. This offers the advantage that no more extensive metallizing or the like more is required between the electrode terminals 115 and the outer surface. Preferably, the second example of an embodiment can provide that on the stiffening bodies 118, 119 on the pressure difference measuring cell 100 remote ends an insulation layer, for example, in the form of a silicon oxide layer and/or an electrically conductive layer, for example, in the form of a highly doped semiconductor layer, is provided. In the case, in which a further electrically conductive layer is provided, this is preferably supplied via the guard-circuit with the potential, so that also its potential tracks the electrode potential.

FIG. 4 represents a sectional view of a third example of an embodiment of a pressure difference sensor along the cutting plane A-A′ of FIG. 1. The third example of an embodiment differs essentially from the first and second examples of embodiments in that of the invention the first and/or second joining layer 116, 117 serve(s) as an electrical shield layer and not as part of the electrically conductive connection.

For this, the circuit connection includes a guard-circuit for setting a shield potential and applying such at least to the first and/or second joining layer(s), so that the first and/or second joining layers serve(s) as an electrical shield layer for the pressure difference measuring cell 100. The guard-circuit is embodied such that it taps an electrode potential of the second electrode as a component of the electrical transducer element and the shield potential is set in such a manner that it tracks the electrode potential, i.e. there is a linear dependence between the two potentials. Regarding the technical embodiment of such a guard-circuit, the international application with the international publication number WO 2016/066306 A1 (US2017315008) is noted, whose content is incorporated here by reference. Especially, the content of its FIG. 5 as well as the associated description of the figure in WO 2016/066306 A1 is likewise incorporated by reference.

### LIST OF REFERENCE CHARACTERS

100 pressure difference measuring cell
101 first platform
102 second platform
103 measuring membrane
104 first insulation layer
105 first electrically conductive layer
106 further insulation layer
107 further electrically conductive layer
108 second insulation layer
109 passageway, or duct
110 second electrode
111 first electrode
112 groove
113 pressure chamber
114 edge region of the first electrically conductive layer
115 electrode terminal
116 first joining layer
117 second joining layer
118 first stiffening element
119 second stiffening element
120 membrane terminal
121 electrode insulating layer

1-13. (canceled)

14. A pressure difference sensor for determining a pressure measurement signal, comprising:
a pressure difference measuring cell including a semiconductor material, wherein the pressure difference measuring cell is suppliable with first and second pressures and, with the use of an electrical transducer element, outputs the pressure measurement signal as a function of a difference between the first and second pressures;
a first stiffening element joined with the pressure difference measuring cell by a first joining layer and having a first duct via which the first pressure is suppliable to the pressure difference measuring cell; and
a second stiffening element joined with the pressure difference measuring cell by a second joining layer and having a second duct via which the second pressure is suppliable to the pressure difference measuring cell;
wherein the first and/or the second joining layer include(s) an electrically conductive material and the first and/or second joining layer provide(s) a mechanical connection of the pressure difference measuring cell with the first and second stiffening elements and also implement an electrical functionality.

15. The pressure difference sensor of claim 14, wherein the first and/or the second joining layer are/is connected with at least one component of the electrical transducer element.

16. The pressure difference sensor of claim 15, wherein the pressure difference measuring cell has a first and a second platform;
wherein each of the first and second platforms includes a layer structure of at least a first electrically conductive layer and a first and second insulation layer;
wherein each of the first and second platforms is connected via the first insulation layer pressure-tightly with a measuring membrane in a peripheral edge region;
wherein the first insulation layer is structured, in each case, such that a pressure chamber is formed between the measuring membrane and the first electrically conductive layer;
wherein each of the first and second platforms is joined, via the first and second joints, respectively, each of which is applied on a second insulation layer of the first and second platforms, respectively, with the first and second stiffening elements, respectively;
wherein each of the first and the second platforms has a passageway, so that the first and second pressures, respectively, are suppliable to respective pressure chambers, in order to enable a pressure-dependent deflection of the measuring membrane;
wherein the pressure-dependent deflection of the measuring membrane is registered via at least one capacitance, which forms between the measuring membrane as a first electrode and at least one subregion of a first electrically conductive layer as a second electrode; and
wherein the second electrode as a component of the electrical transducer element is electrically contacted at least partially through the first, or second, joint with, in each case, an electrode terminal, so that the first or second joint serves at least partially as electrical conductor, or electrically conductive connection.

17. The pressure difference sensor of claim 14, wherein the electrode terminals are arranged on outer surfaces of the first and second platforms extending essentially perpendicularly to the measuring membrane.

18. The pressure difference sensor of claim 14, wherein the electrode terminals are implemented in the form of electrically conductive electrode terminal layers.

19. The pressure difference sensor of claim 16, wherein the electrode terminals are implemented by an outer surface of the first or second stiffening element extending essentially perpendicularly to the measuring membrane.

20. The pressure difference sensor of claim 19, wherein the first or second stiffening element comprises a semiconductor material and forms the outer surface of the first or second stiffening element of the electrode terminals.

21. The pressure difference sensor of claim 16, wherein the layer structure has at least one further insulation layer arranged on the first electrically conductive layer, and a further electrically conductive layer arranged between the second insulation layer and the further insulation layer.

22. The pressure difference sensor of claim 16, wherein the first electrically conductive layer is structured such that the second electrode is separated by a groove from an outer edge of the first electrical layer, so that the second electrode is electrically isolated from the outer edge.

23. The pressure difference sensor of claim 21, further including a guard-circuit for setting a potential and applying the potential to at least the further electrically conductive layer and/or the outer edge, wherein the guard-circuit is embodied such that it taps an electrode potential of the second electrode and the potential is set in such a manner that it essentially tracks the electrode potential.

24. The pressure difference sensor of claim 14, wherein the first and second stiffening elements include a semiconductor material, and the guard-circuit is embodied to apply the potential to an electrically conductive subregion of the first and second stiffening elements.

25. The pressure difference sensor of claim 23, wherein the guard-circuit is embodied such that it applies no potential to the first and/or second joining layer(s).

26. The pressure difference sensor of claim 15, wherein the at least one component is a guard-circuit for setting a shield potential and applying such at least to the first and/or second joining layer and the guard-circuit is embodied such that it taps an electrode potential of the second electrode as a component of the electrical transducer element and the shield potential is set in such a manner that it tracks the electrode potential, so that the first and/or second joining layer(s) serve(s) as an electrical shield layer for the pressure difference measuring cell.
